(19) United States
(12) Patent Application Publication
(10) Pub. No.: US 2010/0199706 A1
(43) Pub. Date: Aug. 12, 2010

(54) AIR FILTER AND REFRIGERATION DEVICE WITH AN AIR FILTER

(75) Inventors: Thomas Bischofberger, Kisslegg (DE); Hans Ihle, Giengen (DE); Andreas Kemmer, Heidenheim (DE); Andreas Kempte, Giengen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/679,705

(22) PCT Filed: Sep. 9, 2008
(86) PCT No.: PCT/EP08/61945

§ 371 Date: Mar. 24, 2010

(30) Foreign Application Priority Data
Oct. 2, 2007 (DE) 10 2007 047 118.3

(51) Int. Cl. F25D 17/06; B01D 50/00

(52) U.S. Cl. 62/419; 55/385.2

(57) ABSTRACT

A refrigerator device having a thermally insulated housing, the interior of which is accessible via a door. The device includes at least one flow duct for the introduction of air into the interior, a fan for generating an air flow along the flow duct, and an air filter arranged in the flow duct. According to an exemplary embodiment of the invention, an air filter for a refrigeration device can be produced with an adequate filter effect with low airflow hindrance into the refrigeration device, wherein the air filter in the flow duct only extends over a part of the flow width thereof. The invention further relates to an air filter designed as a filter cartridge.

The present invention relates to a refrigeration appliance featuring a thermally insulated housing, whose interior is accessible via a door that can be opened and closed, at least one flow path for supplying air into the interior, a blower for generating an airflow along the flow path, and an air filter which is arranged in the flow path. The invention also relates to an air filter having the form of a filter tablet.

DE 23 44 261 A1 discloses a refrigerator for domestic purposes, and describes a filter system by means of which it is possible to eliminate odors that are produced in the storage space for cooled goods. The refrigerator is equipped with an internal air-circulating system comprising a fan and a filter device. The fan is arranged in an insulation material in a lower rear region of the refrigerator. The filter device is arranged in the interior of the refrigerator, specifically in a lower region against one of the two refrigerator side walls, and consists of a housing in which a filter insert is arranged in such a way that it can be exchanged easily. The housing is provided with a lid which, in its closed state, provides an impervious arrangement between filter insert and housing seal. The filter device is situated in a suction duct on the underpressure side of the air-circulating system and completely covers the flow cross-section of said suction duct.

DE 75 16 271 U1 shows a similar solution with regard to flow, and describes an appliance for generating purified cooling air for pharmaceutical cabinets. The appliance consists of a box-type housing, one wall thereof having the form of a finely meshed grid. Various filter mats are arranged behind the grid in the interior of the housing. The interior is divided by an inner wall on which a blower is arranged. A pressure chamber is provided between the inner wall, an outer wall and parts of the remaining walls. At least one pipe nipple from which air hoses extend is attached to the outer wall of the pressure chamber and is connected thereto in a conductive manner. The filter mats are arranged in a suction duct on the underpressure side of the cooling system and completely cover the flow cross-section of said suction duct.

DE 11 2005 001 323 T5 and DE 10 2005 029 419 A1 describe refrigerators having equivalent air purification facilities. The air purification facility comprises a housing having at least one inlet and one outlet, a décor panel which can be moved back and forth in order selectively to open or close the outlet, a filter unit for filtering air that is sucked in via the inlet, a blower for sucking in air via the inlet and for carrying the air away via the outlet after it has been filtered in the filter unit. The filter unit for filtering air that has been sucked in via the inlet is situated in a suction duct on the underpressure side of the air purification facility and completely covers the flow cross-section of said suction duct. The air purification facility is functionally independent from the refrigerator and is positioned separately on the top side thereof.

JP 2005090910 A shows a refrigeration appliance in which an air filter is arranged in a section on the overpressure side of a flow path. The disinfecting filter described therein is arranged subsequent to a ventilator, and is therefore situated on the overpressure side in a section of a flow path. It is clear from the description that the disinfecting filter is located in a flow channel of a separate secondary ventilator. The disinfecting filter and the secondary ventilator are themselves located on the underpressure side in a suction duct of a primary ventilator which generates the actual airflow in the interior of the housing of the refrigeration appliance. The secondary ventilator is not therefore used for generating an airflow for carrying air into an interior of the refrigeration appliance, but merely as an auxiliary ventilator for overcoming a pressure drop at the disinfecting filter. Since the disinfecting filter covers its flow channel completely, the airflow must necessarily be carried through the disinfecting filter completely in order to achieve a filter effect.

The invention addresses the problem of creating an air filter for a refrigeration appliance, said air filter providing an adequate filter effect while presenting less of an obstruction to the airflow in the refrigeration appliance.

The problem is solved by a refrigeration appliance having the features in claim 1.

In order that at least part of the circulating air strikes the air filter, the air filter can be positioned in the airflow without excessively obstructing said airflow. By virtue of the air filter extending over only part of the flow cross-section of the flow path, part of the air flowing along the flow path is carried through the air filter and the remaining part flows around the air filter, without being filtered by the air filter. The portion of the air which flows past the air filter ensures that there is less of an obstruction to the airflow in the refrigeration appliance. At the same time, the portion of air passing through the air filter ensures an adequate filter effect. Evidence shows that it is perfectly sufficient to carry only part of the circulating air through the air filter. As a result of the air being circulated many times, an exchange of filtered air and unfiltered air occurs, such that after being completely mixed the totality of the air is adequately purified in comparison with the original state. The portion of the air flowing past the air filter prevents an excessive pressure drop in the air system, thereby allowing an adequate degree of air exchange to occur. A separate fan or blower for increasing the pressure in front of the air filter is unnecessary in this case. Due to the particularly high demands for energy efficiency in the case of refrigeration appliances, it is advantageous to consider every use of electrical energy. In this regard, the invention relates to a possibility for saving electrical energy in that no additional (second) blower is required, and that the first blower (which must be present) can be operated using the lowest possible pressure drop, whereby the electrical energy consumption of this first blower can be reduced.

The blower according to the invention can be any type of airflow generator. In particular, the blower for aerating the interior of the refrigeration appliance can be a ventilator. The ventilator generally features a rapidly rotating fan wheel, whose blades cause the air to move as a result of their rotational movement. The fan wheel of the ventilator is usually driven by an electric motor.

The air filter which is situated in the flow path, and extends over only part of the flow cross-section thereof, can extend over the center of the flow cross-section. In order to ensure a good flow through the air filter, the air filter can be arranged directly in front of the ventilator in the compression zone. This has the advantage that the air filter is situated at least predominantly in a region where the greatest flow speeds occur. If the air filter is arranged in this region of greatest flow speeds, a greater air volume throughput can be carried through the air filter, according to the portion of the cross-section that is occupied by the air filter relative to the overall flow cross-section. In this way, a predominant portion of the air volume is carried through the air filter and only a lesser portion of the air volume can flow past the air filter. This resolves the diverging objectives of both purifying a maximal portion of the air via the air filter and achieving a minimal pressure drop by virtue of a cross section that is as unobstructed as possible.

For this purpose, the air filter can preferably be arranged in the center of the flow cross-section of the flow path. In terms of flow properties, the flow lines having the highest speeds can be expected to occur in cross-section regions that are situated as far as possible from walls of the flow channel, i.e. preferably in a center of the relevant flow channel. Since the cross section of a flow channel can to a large extent have any shape, the center of the flow path is found where the flow lines having the highest speeds occur, this depending on the contour of the cross section. In addition to the relevant contour of the flow cross-section, this flow property is also dependent on the nature of the inner surface, in particular on the adhesion of the airflow to the surface. In the case of an air pipe having locally varying adhesion of the airflow, therefore, the center of the highest air speeds can also lie outside of the geometric midpoint of the cross section of the circle. This also applies if the air filter is located in a pipe bend.

In all of the embodiments according to the invention, the air filter can be arranged in a section on the overpressure side of the flow path. This has the advantage that, in comparison with an arrangement of the air filter in a section on the underpressure side of the flow path, the air filter is struck with greater pressure, such that sufficient air can pass through even air filters having a high flow resistance. In the case of a micropore air filter which can take the form of an active carbon filter with catalytic effect, for example, a relatively higher flow resistance is produced than in the case of a conventional coarse-pored dust filter with simple filter fleece. According to the invention, it is therefore advantageous, particularly in the case of micropore filters, to arrange these in the overpressure section of the flow path.

The air filter can preferably be mounted in front of an overpressure side of the blower. This has the effect that the airflow can enter the air filter immediately after or at least shortly after leaving the blower. This has the advantage that the airflow enters the air filter with maximal speed and energy. If the air filter was arranged very far from the blower, the airflow would already have lost a considerable amount of flow speed and energy even before reaching the air filter, e.g. due to wall friction in the flow channel, such that the air could only be carried through the air filter with less energy and in smaller quantities. The arrangement of the air filter directly after or at least shortly after leaving the blower therefore results in a high airflow throughput through the air filter. Consequently, less electrical energy for the drive motor of the blower is required for the same air filter performance.

Furthermore, the air filter can be integrated in a protective cover which is mounted in front of the overpressure side of the blower. In order to hold the air filter in the flow path, provision can be made for a separate holder which supports the air filter and is fastened to an inner wall of a flow channel. However, in order to eliminate the need for a separate holder for the air filter, it is proposed that the air filter be integrated in a protective cover at the front of the overpressure side of the blower. A ventilator, which is preferably driven by an electric motor, is usually installed just behind an inner wall of the housing that delimits the interior. In order reliably to prevent access to the electrical conductors from the interior as a result of intervention by a person, the outlet opening of the ventilator or blower is generally provided with a protective cover. The protective cover is designed in such a way that the largest possible cross section remains open for unobstructed passage of the airflow. Moreover, the protective cover is designed so as to reliably prevent intervention by a person, e.g. by the fingers of a hand. To this end, the opening or openings of the airflow must be correspondingly narrow in their configuration. The protective cover is usually designed as a grid which can be made of plastic, for example. According to the invention, a protective cover which is already required for safety reasons is used as a holder for the air filter in a manner which combines its functions. This advantageously removes the need for a separate holder, thereby reducing the manufacturing costs.

In this case, for the purpose of holding the air filter in an exchangeable manner, the protective cover can feature a receptacle for the air filter. The air filter is preferably held in an exchangeable manner. To this end, the protective cover is not plane, but is provided with a bay-shaped receptacle. This receptacle can be an integral part of the protective cover. The receptacle can project in a bay-like manner into the protective cover to the extent that the air filter is completely contained therein, wherein said air filter takes the form of a filter tablet in particular. Once the air filter has been fully inserted into the receptacle recess, the remaining through-opening can be shut by means of a lid that can be opened and closed, such that the air filter is held firmly and cannot fall out of the protective cover.

The receptacle recess of the protective cover can feature an open side, which can be shut by the lid and is oriented towards the interior of the refrigeration appliance. The shuttable open side forms a through-opening accordingly, via which a used air filter can be removed from the protective cover and a new air filter can be inserted. In order that the exchange of the air filter can be performed autonomously by a user, the open side is oriented towards the interior of the refrigeration appliance, and therefore the user can open the lid and remove the air filter from the receptacle via the interior when the door of the refrigeration appliance is open. In this respect, the air filter can be removed or exchanged by a user via an opening that is accessible from the interior. In order to ensure the necessary electrical safety, the ventilator cover itself cannot be removed by the user. If the user does not want any filtering, the refrigeration appliance can also be operated in a reliable manner without an air filter being inserted, i.e. the bay-shaped recess for accommodating the air filter is barred in a grid-like manner relative to the ventilator, such that intervention in the region of the ventilator is reliably prevented even if the air filter has been removed. The air filter is easy to exchange, since it can be recognized quickly and clearly when the user has opened the door of the refrigeration appliance. In addition, it is easy for the user to see whether an air filter has been inserted, and the air-purifying action is therefore visible to the user in the interior of the refrigeration appliance.

The invention also relates to an air filter which is embodied as a filter tablet, this being designed for insertion into a receptacle recess of a protective cover of a blower, wherein said receptacle recess can be shut by means of a lid. The air filter is preferably designed as an active carbon filter with catalytic effect. By virtue of the design of the air filter as a filter tablet, the air filter is situated directly in the airflow and can therefore realize its odor-reducing potential and its air-purifying effect.

The filter tablet can have a size which, in its mounted position in the protective cover of the blower, extends over only part of the flow cross-section of the protective cover. In particular, the filter tablet can have a convenient size such that the filter tablet can be inserted into the receptacle recess in the interior of the refrigeration appliance using two fingers of one hand. The filter tablet can be designed in the shape of a cuboid. This basic shape is already known in the context of cleaning tablets for dishwashers, for example. Due to the special format of the air filter as a filter tablet, the user can be prompted to operate in a similar manner as in the case of cleaning tablets for dishwashers. The result is that the user is reminded to exchange the air filter regularly and hence at the correct time, before the air-purifying effect decreases.

An embodiment of the invention is described with reference to a refrigeration appliance which is illustrated as an example in the figures. The detailed description of this specific exemplary embodiment also reveals further general features and advantages of the present invention.

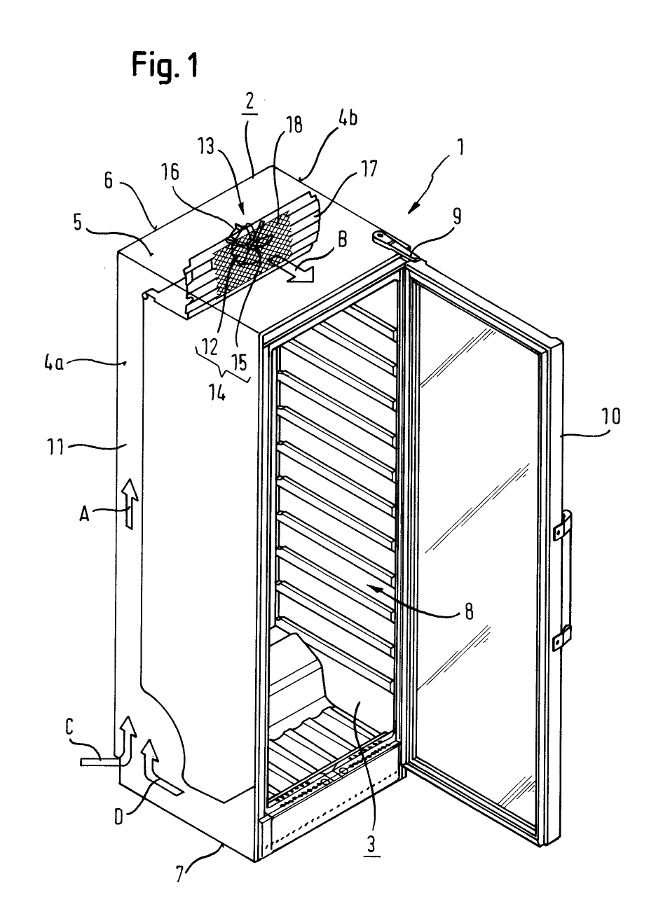

FIG. 1 shows a perspective view of a refrigeration appliance for domestic purposes, comprising a blower for directing the air and a protective cover which is mounted in front of said blower;

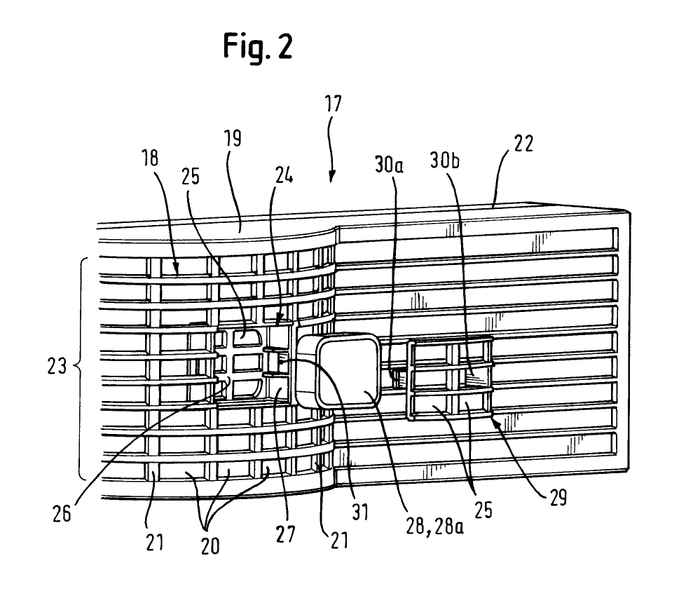

FIG. 2 shows a perspective view of a protective cover, featuring an integrated receptacle recess for a filter tablet as per the invention.

A refrigeration appliance 1 as per FIG. 1 features a thermally insulated housing 2. The housing 2 comprises a bay-shaped inner container 3, two opposing lateral décor walls 4a and 4b, a top panel 5, a rear wall 6 and a floor panel 7. An intermediate space is formed between the décor walls 4a and 4b, the top panel 5, the rear wall 6, the floor panel 7 and the inner container 3, wherein said intermediate space is filled with thermal insulation material (in particular a thermal insulation foam) in order to achieve a thermal insulation effect. The inner container 3 is open on the front side and delimits an interior 8 which can be thermally sealed by means of a door 10 which is pivotably mounted on the housing 2 via hinges 9. An air flow channel 11 runs on the outside of the inner container 3 and defines a flow path A,B,C,D along which air is carried by means of a blower 13 that is arranged in the flow path A,B,C,D. The blower 13 consists of a ventilator 14, a plurality of blades 12 being arranged around its ventilator shaft 15. The ventilator shaft 15 is driven in a rotary direction by means of an electric motor 16. The blades 16 are set into motion by a rotation of the ventilator shaft 15, and carry air from the flow channel 11 (arrow A) into the interior 8 (arrow B). The air that is sucked out of the flow channel 11 by the blower 13 can either be air that is drawn in from the environment as illustrated by arrow C or circulated air from the interior 8 as illustrated by arrow D. A protective cover 17 is mounted subsequent to the blower 13 and is oriented towards the interior 8, i.e. the protective cover 17 shields the blower 13 against the interior 8. A partial surface of the protective cover 17 is designed as an outlet grid 18.

Part of the protective cover 17 is illustrated in FIG. 2. The protective cover 17 features a central section 19 which is provided with a multiplicity of outlet openings 20. The outlet openings 20 are delimited by margins 21. In the exemplary embodiment shown here, the margins 21 are designed as straight ribs which frame rectangular outlet openings 20. In this respect, the margins 21 form the outlet grid 18. In addition to this central section 19, the protective cover 17 features two further lateral sections. The lateral sections are formed on opposite sides of the central section 19 in a mirror-symmetrical arrangement on the protective cover 17. A lateral section 22 is illustrated in FIG. 2. The lateral section 22 is formed without flow openings. Only the outlet grid 18 defines a flow cross-section 23 on the overpressure side. The outlet grid 18 is mounted directly in front of the blower 13. For the purpose of improving uniform air distribution in the interior 8, the central section 19 or the outlet grid 18 is curved, such that air which flows through the outlet grid 18 can emerge in a wide fan into the interior 8. Provision is made for a receptacle 24 in the center of the outlet grid 18. The receptacle 24 forms a recess which is set back, in the direction of the blower 13, from the surface of the outlet grid 18 facing the interior. The recess-like receptacle 24 has a base surface 26 which features gaps 25 and is connected to the surface of the outlet grid by means of side walls 27. The side walls 27 delimit the receptacle 24 approximately in the form of a rectangle. The side walls 27 can be provided either with or without gaps. The receptacle 24 is preferably an integral part of the outlet grid 18 or the protective cover 17. An air filter 28 has a shape which essentially matches the shape of the receptacle 24. In the exemplary embodiment shown here, the air filter 28 has a cuboid shape, such that a type of filter tablet 28a is developed. The cuboid filter tablet 28a is rectangular in profile and has side edges of equal length, the length of said side edges being in each case at least approximately a third or up to half of the width or height of the outlet grid 18. A lid 29 is provided to fix the filter tablet in the receptacle 24. The size of the lid 29 matches the open side of the receptacle 24. Catch means 30a and 30b are provided on opposite sides of the lid 29 and allow the lid 29 to be arrested in a detachable manner by reciprocal catch means 31 of the outlet grid 18. The lid 29 is provided with gaps 25 in the same way as the base surface 26 of the receptacle 24. The filter tablet 28a can have a color which contrasts with the outlet grid 18, such that it is easy to see through the gaps 25 whether a filter tablet 28a is inserted or not.

1-11. (canceled)

12. A refrigeration appliance comprising:
a thermally insulated housing, the interior thereof being accessible via a door that can be opened and closed;
at least one flow path for supplying air into the interior;
a blower for generating an airflow along the flow path; and
an air filter which is arranged in the flow path and extends over only part of a flow cross-section thereof.

13. The refrigeration appliance as claimed in claim 12, wherein the air filter extends over a center of the flow cross-section.

14. The refrigeration appliance as claimed in claim 13, wherein the air filter is arranged in the center of the flow cross-section in the flow path.

15. The refrigeration appliance as claimed in claim 13, wherein the air filter is arranged such that a center of the air filter lies in the center of the flow cross-section.

16. The refrigeration appliance as claimed in claim 13, wherein the air filter is arranged in a section on an overpressure side of the flow path.

17. The refrigeration appliance as claimed in claim 16, wherein the air filter is arranged such that it is mounted in front of an overpressure side of the blower.

18. The refrigeration appliance as claimed in claim 16, wherein the air filter is integrated in a protective cover and arranged such that is mounted in front of an overpressure side of the blower.

19. The refrigeration appliance as claimed in claim 18, wherein the protective cover for holding the air filter in an exchangeable manner comprises a receptacle for the air filter.

20. The refrigeration appliance as claimed in claim 19, wherein the receptacle is structured to include a recess which can be shut by a lid and comprises an open side that faces an interior of the refrigeration appliance.

21. An air filter for a refrigeration appliance as claimed in claim 12, wherein the air filter is a filter tablet structured for insertion in a recess-type receptacle of a protective cover of the blower, wherein said receptacle can preferably be shut by a lid.

22. The air filter as claimed in claim 21, wherein the filter tablet has a size which, in its mounted position in the protective cover of the blower, extends over only part of the flow cross-section of the protective cover.
